(19) United States
(12) Patent Application Publication
(10) Pub. No.: US 2023/0215443 A1
(43) Pub. Date: Jul. 6, 2023

(54) SIGNAL PROCESSING APPARATUS, ENCODING METHOD, AND SIGNAL PROCESSING SYSTEM

(71) Applicant: SONY GROUP CORPORATION, TOKYO (JP)

(72) Inventors: RYUJI TOKUNAGA, TOKYO (JP); CHISATO KEMMOCHI, TOKYO (JP); TAKAFUMI HATTORI, TOKYO (JP); AKIO TANAKA, TOKYO (JP); YASUHIRO TOGURI, TOKYO (JP)

(21) Appl. No.: 18/000,556

(22) PCT Filed: May 28, 2021
(86) PCT No.: PCT/JP2021/020437

§ 371 Date: Dec. 2, 2022

(30) Foreign Application Priority Data
Jun. 11, 2020 (JP) 2020-101847

(51) Int. Cl. G10L 19/005; G10L 19/008

(52) U.S. Cl. CPC G10L 19/005; G10L 19/008

(57) ABSTRACT

The present technology relates to a signal processing apparatus, an encoding method, and a signal processing system that allow reproduction quality to be improved. A signal processing apparatus receives packets that are separated for respective channels and each additionally include identification information, stores the packets in a buffer in reference to the identification information, and decodes those of the packets which are directed to the signal processing apparatus. The present technology can be applied to an audio reproduction system that reproduces audio data for two channels.

### TECHNICAL FIELD

The present technology relates to a signal processing apparatus, an encoding method, and a signal processing system, and in particular, to a signal processing apparatus, an encoding method, and a signal processing system that allow reproduction quality to be improved.

### BACKGROUND ART

In recent years, a wireless audio earphone with separate channels has been popular (see PTL 1). The audio earphone includes a typical 2-channel system.

Further, the audio earphone transmits audio data as follows. Specifically, a server transmits stereo-encoded audio data to a reproduction apparatus for a left channel (Lch) (hereinafter referred to as the reproduction apparatus (Lch)), and the reproduction apparatus (Lch) transfers the audio data to a reproduction apparatus for a right channel (Rch) (hereinafter referred to as a reproduction apparatus (Rch). In such a manner, the audio data is received by each reproduction apparatus, and the received audio data is reproduced in each reproduction apparatus.

### CITATION LIST

### Patent Literature

[PTL 1]
Japanese Patent Laid-open No. 2018-42241

### SUMMARY

### Technical Problem

As described above, the transmission system of the wireless audio earphone with separate channels requires a separate transmission band for transmission from the reproduction apparatus (Lch) to the reproduction apparatus (Rch). Consequently, the transmission band used by the audio earphone is approximately double the transmission band used by a known wireless audio earphone with an unseparated channel (hereinafter referred to as a known earphone).

Thus, the transmission system of the wireless audio earphone with separate channels has difficulty in increasing an encoding bit rate of the audio earphone to a value comparable to that of the known earphone. Consequently, the sound quality of the audio earphone is lower than that of the known earphone.

In view of such a situation, an object of the present technology is to allow reproduction quality to be improved.

### Solution to Problem

A signal processing apparatus of a first aspect of the present technology includes a processing section that receives packets which are separated for respective channels and each additionally include identification information, stores the packets in a buffer in reference to the identification information, and decodes those of the packets which are directed to the signal processing apparatus.

An encoding method of a second aspect of the present technology includes separating audio data into data for respective channels and monaurally encoding the data, generating a packet by adding identification information to the encoded data, and transmitting the packet generated to a first signal processing apparatus.

A signal processing system of a third aspect of the present technology includes an encoding apparatus that separates audio data into separate data for respective channels and monaurally encodes the data, generates a packet by adding identification information to the encoded data, and transmits the packets generated to a first signal processing apparatus, the first signal processing apparatus that receives the packet transmitted from the encoding apparatus, stores the packet in a first buffer in reference to the identification information, decodes the packet which is directed to the first signal processing apparatus, and, in response to a request from a second signal processing apparatus, transmits, to the second signal processing apparatus, the packet directed to the second signal processing apparatus and stored in the first buffer, and the second signal processing apparatus that monitors communication between the encoding apparatus and the first signal processing apparatus and receives the packet transmitted from the encoding apparatus to the first signal processing apparatus, stores the packet in a second buffer in reference to the identification information, detects a lost packet in reference to the identification information, transmits, to the first signal processing apparatus, the request for the lost packet detected, and receives, from the first signal processing apparatus, the packet corresponding to the request and decodes the packet directed to the second signal processing apparatus.

In the first aspect of the present technology, packets which are separated for respective channels and each additionally include identification information are received, and the packets are stored in the buffer in reference to the identification information. Then, those of the packets which are directed to the signal processing apparatus are decoded.

In the second aspect of the present technology, audio data is separated into data for respective channels, and the data is monaurally encoded. Further, a packet is generated by identification information being added to the encoded data, and the packet generated is transmitted to a first signal processing apparatus.

In the third aspect of the present technology, the encoding apparatus separates audio data into separate data for respective channels and monaurally encodes the data, generates a packet by adding identification information to the encoded data, and transmits the packet generated to the first signal processing apparatus. The first signal processing apparatus receives the packet transmitted from the encoding apparatus, stores the packet in the first buffer in reference to the identification information, decodes the packet which is directed to the first signal processing apparatus, and, in response to a request from the second signal processing apparatus, transmits, to the second signal processing apparatus, the packet directed to the second signal processing apparatus and stored in the first buffer. The second signal processing apparatus monitors communication between the encoding apparatus and the first signal processing apparatus, receives the packet transmitted from the encoding apparatus to the first signal processing apparatus, stores the packet in the second buffer in reference to the identification information, detects a lost packet in reference to the identification information, transmits, to the first signal processing apparatus, the request for the lost packet detected, receives, from the first signal processing apparatus, the packet corresponding to the request and decodes the packet directed to the second signal processing apparatus.

### BRIEF DESCRIPTION OF DRAWINGS

FIG. 1 is a diagram depicting a configuration example of a known audio reproduction system.

FIG. 2 is a diagram depicting another configuration example of the known audio reproduction system.

FIG. 3 is a block diagram depicting a configuration example of a first embodiment of an audio reproduction system to which the present technology is applied.

FIG. 4 is a diagram depicting a configuration example of packets.

FIG. 5 is a diagram depicting an example of high bit rate transmission.

FIG. 6 is a diagram depicting an example of low bit rate transmission.

FIG. 7 is a flowchart illustrating processing executed by an audio reproduction system in FIG. 3.

FIG. 8 is a block diagram illustrating a configuration example of a second embodiment of the audio reproduction system to which the present technology is applied.

FIG. 9 is a diagram illustrating an example of a compensation method.

FIG. 10 is a diagram depicting a configuration example of a third embodiment of the audio reproduction system to which the present technology is applied.

FIG. 11 is a diagram depicting a configuration example of a fourth embodiment of the audio reproduction system to which the present technology is applied.

FIG. 12 is a block diagram depicting a configuration example of a fifth embodiment of the audio reproduction system to which the present technology is applied.

FIG. 13 is a block diagram depicting a configuration example of a computer.

### DESCRIPTION OF EMBODIMENTS

Embodiments of the present technology will be described below. The description is given in the following order.

0. Known Configuration

1. First Embodiment (2-channel Configuration)

2. Second Embodiment (Multichannel Configuration)

3. Third Embodiment (Dynamic Addition of Reproduction Apparatus)

4. Fourth Embodiment (Installation in Multiple Rooms)

5. Fifth Embodiment (Streaming Service from Cloud)

6. Others

### 0. Known Configuration

### (Configuration Example of Known System)

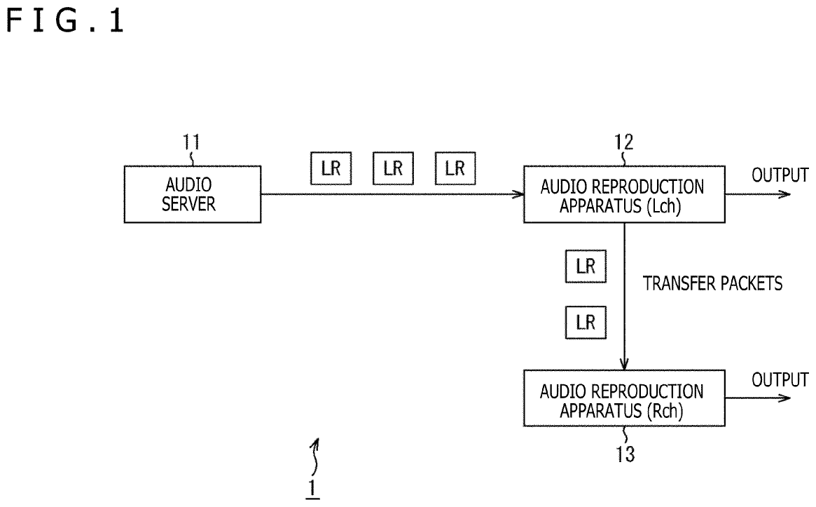

FIG. 1 is a diagram illustrating a configuration example of a known audio reproduction system with separate channels.

An audio reproduction system 1 in FIG. 1 includes an audio server 11, an audio reproduction apparatus 12 that reproduces audio data for Lch, and an audio reproduction apparatus 13 that reproduces audio data for Rch.

The audio server 11 transmits, to the audio reproduction apparatus 12, packets LR obtained by stereo-encoding audio data for Lch and audio data for Rch.

The audio reproduction apparatus 12 receives packets LR transmitted from the audio server 11, decodes audio data for Lch extracted from the received packets LR, and outputs a decoded sound for Lch.

Further, the audio reproduction apparatus 12 transfers the received packets LR to the audio reproduction apparatus 13.

The audio reproduction apparatus 13 receives the packets LR transferred from the audio reproduction apparatus 12, decodes audio data for Rch extracted from the received packets LR, and outputs a decoded sound for Rch.

The audio reproduction system 1 in FIG. 1 requires a transmission band for transmission from the audio reproduction apparatus 12 to the audio reproduction apparatus 13 besides a transmission band for transmission from the audio server 11. Consequently, the transmission band used by the audio reproduction system 1 is approximately double the transmission band used by the known audio earphone with an unseparated channel. Hence, the audio reproduction system 1 has difficulty in increasing the encoding bit rate of the audio reproduction system 1 to a value comparable to that of the transmission band of the known earphone. Consequently, the audio reproduction system 1 has lower sound quality than the known earphone.

Further, in the audio reproduction system 1, the moment transmission between the audio reproduction apparatus 12 and the audio reproduction apparatus 13 becomes unstable, the reproduction quality of the audio reproduction apparatus 13 is degraded. The degraded reproduction quality is, for example, revealed by breakup of sound for Rch and sound out-of-sync between Lch and Rch.

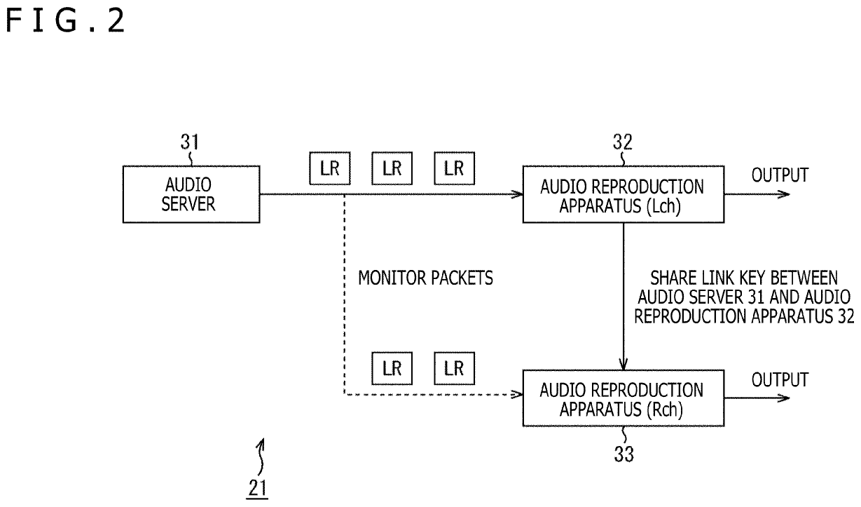

FIG. 2 is a diagram depicting another configuration example of the known audio reproduction system with separate channels.

An audio reproduction system 21 in FIG. 2 includes an audio server 31, an audio reproduction apparatus 32 that reproduces audio data for Lch, and an audio reproduction apparatus 33 that reproduces audio data for Rch.

The audio server 31 transmits, to the audio reproduction apparatus 32, packets LR obtained by stereo-encoding audio data for Lch and audio data for Rch.

The audio reproduction apparatus 32 receives the packets LR transmitted from the audio server 31, decodes audio data for Lch extracted from the received packets LR, and outputs a decoded sound for Lch.

The audio reproduction apparatus 33 acquires, from the audio reproduction apparatus 32, a link key used for transmission between the audio server 31 and the audio reproduction apparatus 32, and shares the link key. The link key is, for example, an encryption key used for a synchronization establishment procedure between the audio server 31 and the audio reproduction apparatus 32, and the like. By using the link key acquired, the audio reproduction apparatus 33 can monitor packets transmitted between the audio server 31 and the audio reproduction apparatus 32. This allows the audio reproduction apparatus 33 to acquire the packets LR obtained by stereo-encoding and transmitted between the audio server 31 and the audio reproduction apparatus 32.

The audio reproduction apparatus 33 decodes audio data for Rch extracted from the packets LR acquired, and outputs the decoded audio for Rch.

For the audio reproduction system 21 in FIG. 2, only the transmission band between the audio server 31 and the audio reproduction apparatus 32 needs to be taken into account. Consequently, the audio reproduction system 21 enables the encoding bit rate to be increased up to a value for the transmission band of the known earphone. This allows the audio reproduction system 21 to achieve sound quality comparable to that of the known earphone.

However, the audio reproduction system 21 includes no means for retransmitting a packet from the audio server 31 to the audio reproduction apparatus 33 in a case where the audio reproduction apparatus 33 detects any lost packet. Hence, the audio reproduction apparatus 33 has degraded reproduction quality. The degraded reproduction quality is, for example, revealed by breakup of sound for Rch and sound out-of-sync between Lch and Rch.

As such, in the present technology, packets which are separated for respective channels and each additionally include identification information are received, the packets are stored in a buffer in reference to the identification information, and those of the packets which are directed to the signal processing apparatus are decoded. Here, the identification information is information for identifying each packet and includes destination information (ID information), a sequence number, and the like for each channel further provided in the packet data. In addition, the identification information may be information additionally provided in the packet data as meta information.

Thus, packets are stored in the buffer in reference to the identification information, and hence, packets corresponding to another apparatus different from the signal processing apparatus can be transmitted to the other apparatus. Consequently, in a case where any lost packet is detected in another apparatus, a packet corresponding to the detected lost packet can be transmitted. This allows the reproduction quality to be improved.

### 1. First Embodiment (2-Channel Configuration

### (Configuration of Audio Reproduction System)

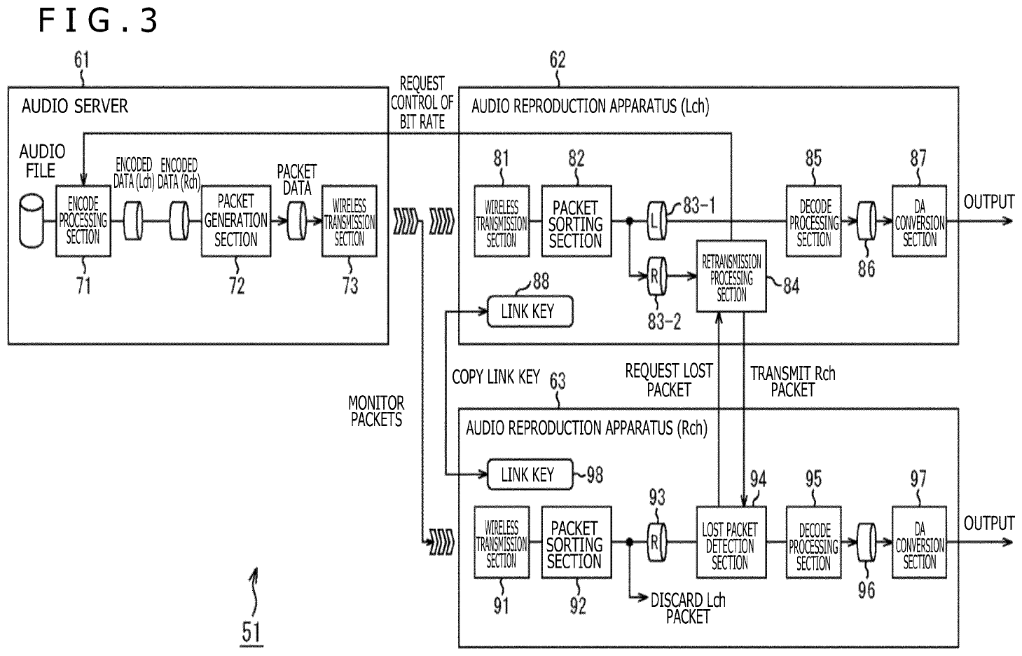

FIG. 3 is a block diagram depicting a configuration example of a first embodiment of the audio reproduction system to which the present technology is applied.

An audio reproduction system 51 in FIG. 3 is a system that reproduces audio data for two channels.

The audio reproduction system 51 includes an audio server 61, an audio reproduction apparatus 62 that reproduces audio data for Lch, and an audio reproduction apparatus 63 that reproduces audio data for Rch.

The audio server 61 includes, for example, a smartphone, a tablet terminal, a dedicated reproduction terminal, or the like. Each of the audio reproduction apparatus 62 and the audio reproduction apparatus 63 includes, for example, a wireless earphone. The audio server 61 and the audio reproduction apparatus 62 are enabled to transmit data through a synchronization establishment procedure defined for wireless transmission.

The audio server 61 includes an encode processing section 71, a packet generation section 72, and a wireless transmission section 73.

The encode processing section 71 loads a stereo audio file (PCM data) to generate encoded data. In the known art, encoded data obtained by stereo-encoding is generated for stereo audio files. In the case of the present technology, the encode processing section 71 separates a stereo audio file into data for respective channels, and monaurally encodes the data to generate 2-channel encoded data including separate data for the respective channels (encoded data for Lch and encoded data for Rch).

Further, in a case where the audio reproduction apparatus 62 requests the encode processing section 71 to control the bit rate, the encode processing section 71 controls the encoding bit rate.

The packet generation section 72 adds a destination ID and a sequence number for each channel to each of the encoded data for Lch and the encoded data for Rch, as header data, to generate one packet.

The wireless transmission section 73 transmits, to the audio reproduction apparatus 62, packets generated by the packet generation section 72.

### (Configuration Example of Packets)

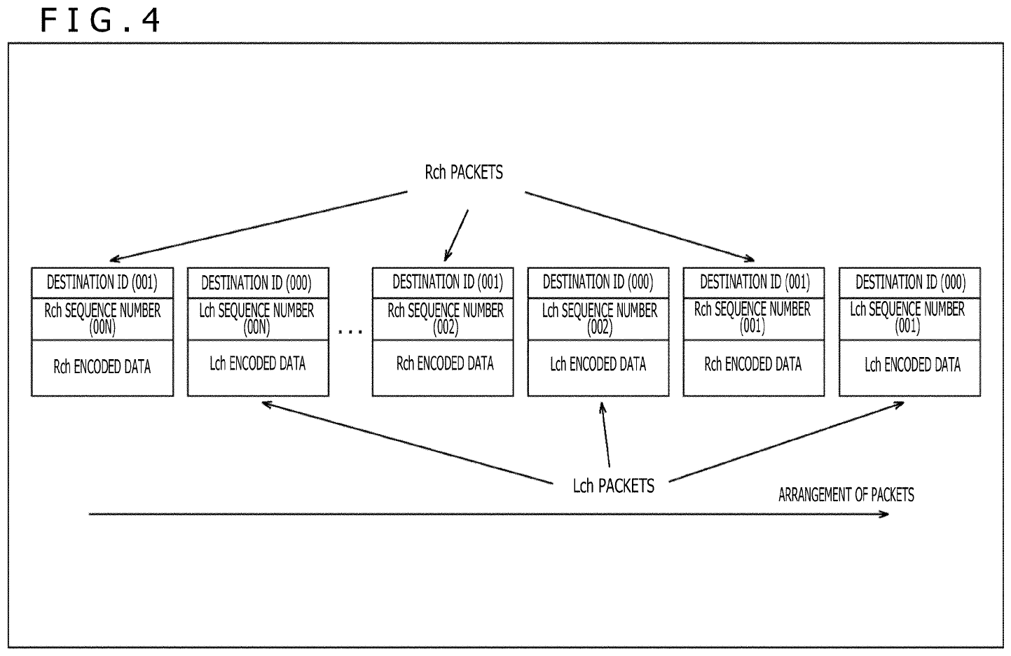

FIG. 4 is a diagram depicting a configuration example of packets generated by the packet generation section 72.

A horizontal axis in FIG. 4 represents the arrangement of packets transmitted between the audio server 61 and the audio reproduction apparatus 62. Lch packets and Rch packets are alternately arranged from right to left in FIG. 4.

The Lch packet includes Lch encoded data and further includes, as header data, a destination ID (000) and an Lch sequence number (001, 002, . . . , 00N).

The Rch packets includes Rch encoded data and further includes, as header data, a destination ID (001) and an Rch sequence number (001, 002, . . . , 00N).

The destination ID is an ID number indicating an audio reproduction apparatus. In the case of FIG. 4, the audio reproduction apparatus 62 that reproduces audio data for Lch is assigned the destination ID 000. The audio reproduction apparatus 63 that reproduces audio data for Rch is assigned the destination ID 001.

Each of the Lch sequence number and the Rch sequence number indicates the sequence number of encoded data for the corresponding channel. Note that each packet may additionally contain meta information other than the destination ID and the sequence number.

Lch packets and Rch packets configured as described above are alternately transmitted to the audio reproduction apparatus 62.

The audio reproduction apparatus 62 includes a wireless transmission section 81, a packet sorting section 82, packet buffers 83-1 and 83-2, a retransmission processing section 84, a decode processing section 85, a PCM buffer 86, a DA (Digital to Analog) conversion section 87, and a link key storage section 88.

The wireless transmission section 81 receives Lch packets and Rch packets transmitted from the audio server 61. The wireless transmission section 81 outputs the received Lch packets and Rch packets to the packet sorting section 82.

By using the destination ID as a key, the packet sorting section 82 sorts the packets supplied from the wireless transmission section 81 into packets directed to the audio reproduction apparatus 62 and the packets directed to another audio reproduction apparatus. The packet sorting section 82 stores, in the packet buffer 83-1, the packets directed to the audio reproduction apparatus 62, and stores, in the packet buffer 83-2, the packets directed to the other audio reproduction apparatus (audio reproduction apparatus 63 in the case of FIG. 3).

Specifically, the packet buffer 83-1 stores the Lch packets. The packet buffer 83-2 stores the Rch packets.

In response to a request for a lost packet transmitted from the audio reproduction apparatus 63, the retransmission processing section 84 retrieves, from the packet buffer 83-2, an Rch packet corresponding to the requested lost packet, and transmits the Rch packet to the audio reproduction apparatus 63. At that time, the retransmission processing section 84 requests the audio server 61 to control and reduce the bit rate. Further, in a case where the transmission of the Rch packet to the audio reproduction apparatus 63 is completed, the retransmission processing section 84 requests the audio server 61 to control and increase the bit rate.

The decode processing section 85 retrieves the Lch packets from the packet buffer 83-1 to decode the Lch packets, and stores, in a PCM buffer 86, PCM data resulting from the decoding.

The DA conversion section 87 converts digital PCM data accumulated in the PCM buffer 86 into analog data, and outputs analog audio data.

The link key storage section 88 stores a link key obtained in the synchronization establishment procedure between the audio server 61 and the audio reproduction apparatus 62. In response to a request from the audio reproduction apparatus 63, the link key is transmitted (copied) to the audio reproduction apparatus 63 by the wireless transmission section 81.

The audio reproduction apparatus 63 includes a wireless transmission section 91, a packet sorting section 92, a packet buffer 93, a lost packet detection section 94, a decode processing section 95, a PCM buffer 96, a DA (Digital to Analog) conversion section 97, and a link key storage section 98.

The audio reproduction apparatus 63 includes a function to monitor packets transmitted between the audio server 61 and the audio reproduction apparatus 62. Specifically, when initiating communication with the audio reproduction apparatus 62, the wireless transmission section 91 can monitor packets transmitted between the audio server 61 and the audio reproduction apparatus 62 by acquiring the link key from the audio reproduction apparatus 62.

The wireless transmission section 91 monitors the packets transmitted between the audio server 61 and the audio reproduction apparatus 62 and receives Lch packets and Rch packets transmitted from the audio server 61. The wireless transmission section 91 outputs the received Lch packets and Rch packets to the packet sorting section 92.

By using the destination ID as a key, the packet sorting section 92 sorts the packets supplied from the wireless transmission section 91 into packets directed to the audio reproduction apparatus 63 and the packets directed to another audio reproduction apparatus. Note that the packets may be sorted by use of the channel as a key. The packet sorting section 92 stores, in the packet buffer 93, the packets directed to the audio reproduction apparatus 63, and discards the packets directed to the other audio reproduction apparatus (audio reproduction apparatus 62 in the case of FIG. 3).

Here, packet loss is inherent in wireless transmission due to a degraded state of radio waves. However, in the present technology, audio packets are generated one by one for each channel, and hence the audio reproduction apparatus 63 allows the packet sorting section 92 to select only the packets of audio data with the destination ID indicating the audio reproduction apparatus 63 and store the packets.

In other words, the audio reproduction apparatus 63 can ignore packets with the destination ID indicating the other audio reproduction apparatus even in a case where there is any lost packet. Thus, the probability of a lost packet with the destination ID indicating the audio reproduction apparatus 63 is approximately half the probability of a lost packet in the known system in FIG. 1 and FIG. 2.

The lost packet detection section 94 detects a lost packet. Specifically, the lost packet detection section 94 checks the sequence number in each of the packets that are stored in the packet buffer 93 and that include the destination ID indicating the audio reproduction apparatus 63. In a case of detecting loss of a sequence number, the lost packet detection section 94 requests a packet with the lost sequence number (lost packet) from the audio reproduction apparatus 62. The lost packet detection section 94 receives a packet transmitted from the audio reproduction apparatus 62, in response to the request for the lost packet.

The decode processing section 95 retrieves the Rch packets from the packet buffer 93 to decode the Rch packets, and stores, in the PCM buffer 96, PCM data resulting from the decoding.

The DA conversion section 97 converts the digital PCM data accumulated in the PCM buffer 96 into analog data, and outputs analog audio data.

As described above, the link key storage section 98 stores the link key transmitted from the audio reproduction apparatus 62 and received by the wireless transmission section 91.

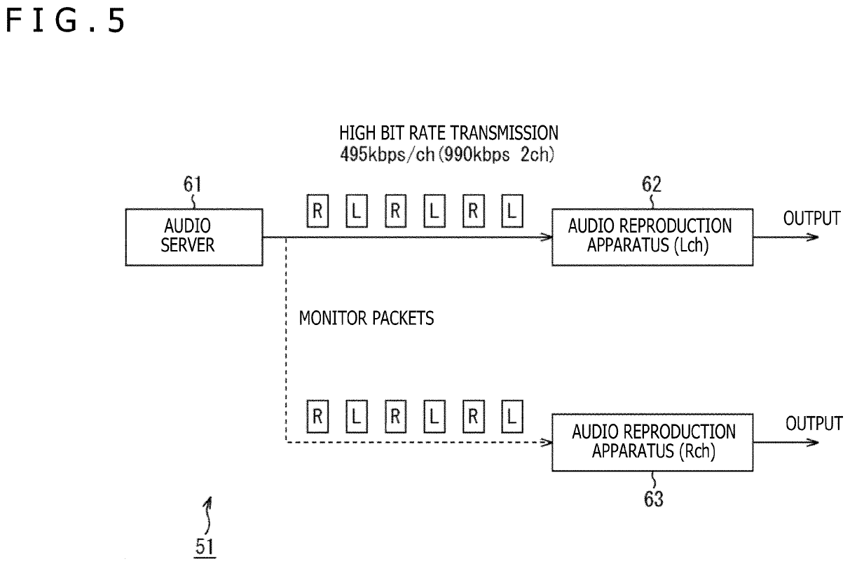

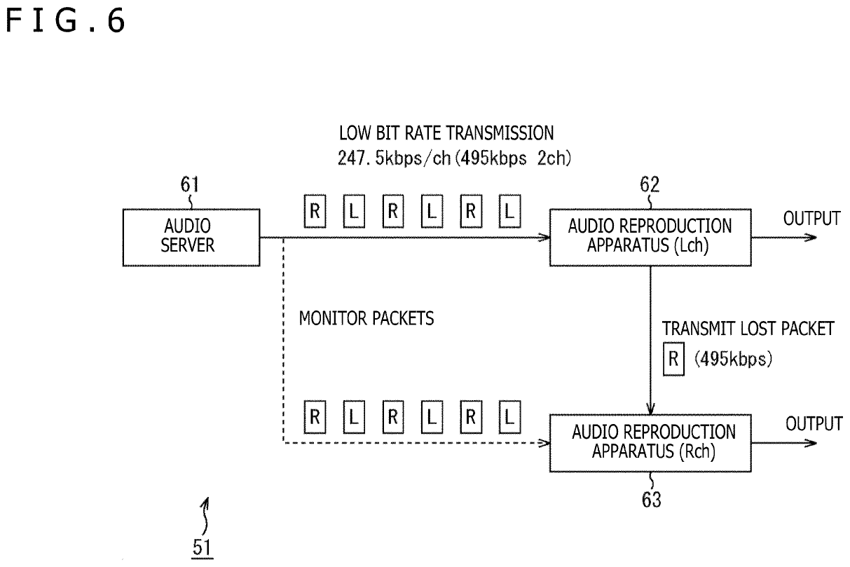

Now, with reference to FIG. 5 and FIG. 6, control of the bit rate of the audio reproduction system 51 will be described.

In the audio reproduction system 51, to achieve maximum sound quality, the encode processing section 71 of the audio server 61 encodes audio data with the bit rate increased up to the upper limit of the transmission band.

FIG. 5 is a diagram depicting an example of high bit rate transmission.

In FIG. 5, the transmission band has an upper limit of 990 kbps, and Lch packets and Rch packets encoded by the audio server 61 are transmitted and are received by the audio reproduction apparatus 62 in such a manner that the bit rate is 495 kbps/ch.

By monitoring the packets transmitted between the audio server 61 and the audio reproduction apparatus 62, the audio reproduction apparatus 63 receives the Lch packets and the Rch packets encoded by the audio server 61.

However, transmission of the packets from the audio reproduction apparatus 62 to the audio reproduction apparatus 63 causes the upper limit of the transmission band to be exceeded.

Thus, in the present technology, low bit rate transmission is performed in such a manner that the total of (1) a transmission band used between the audio server 61 and the audio reproduction apparatus 62 and (2) a transmission band used in packet transmission from the audio reproduction apparatus 62 to the audio reproduction apparatus 63 is equal to or smaller than the upper limit of the transmission band.

FIG. 6 is a diagram depicting an example of low bit rate transmission.

In FIG. 6, a lost packet is transmitted from the audio reproduction apparatus 62 to the audio reproduction apparatus 63. The lost packet is already accumulated in the audio reproduction apparatus 62 during high bit rate transmission. Consequently, the bit rate for the lost packet is 495 kbps.

Between the audio server 61 and the audio reproduction apparatus 62, the audio server 61 encodes and transmits the Lch packets and the Rch packets at 247.5 kbps/ch (495 kbps for two channels) to efficiently consume the remaining transmission band.

When the transmission of the packets from the audio reproduction apparatus 62 to the audio reproduction apparatus 63 is completed, the audio reproduction apparatus 62 requests the audio server 61 to control and increase the bit rate.

Instead of or in addition to the present technology described above, with the transmission between the audio server 61 and the audio reproduction apparatus 62 suspended, packets may be transmitted from the audio reproduction apparatus 62 to the audio reproduction apparatus 63. However, in this case, each of the packet buffers 83-1 and 83-2 needs to have a size enough to prevent sound breakup during suspension.

However, when the transmission is continued with the bit rate between the audio server 61 and the audio reproduction apparatus 62 reduced as in the present technology, each of the packet buffers 83-1 and 83-2 can advantageously have a reduced size.

When the bit rate between the audio server 61 and the audio reproduction apparatus 62 is reduced to make a certain range in the transmission band available, the audio reproduction apparatus 62 starts transmitting packets to the audio reproduction apparatus 63. This compensates for the lost packet in the audio reproduction apparatus 63, and the audio reproduction apparatus 63 has improved reproduction quality compared to the known system in FIG. 1 and FIG. 2.

### (Operations of Audio Reproduction System)

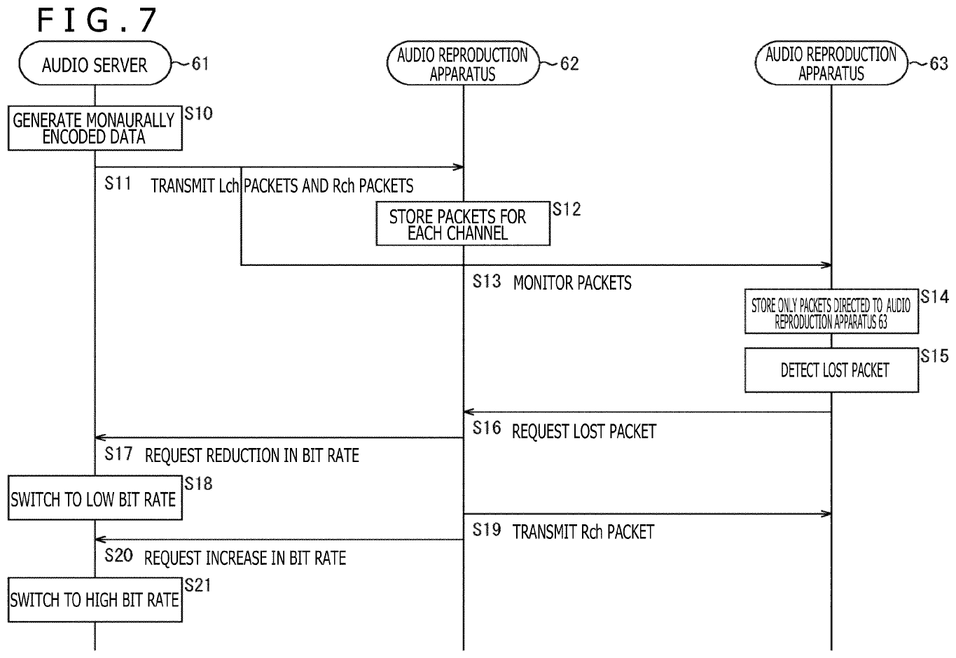

FIG. 7 is a flowchart illustrating processing executed by the audio reproduction system 51 in FIG. 3.

In step S10, the encode processing section 71 of the audio server 61 monaurally encodes a stereo audio file to generate encoded data for two channels (encoded data for Lch and encoded data for Rch).

In step 511, the packet generation section 72 generates Lch packets and Rch packets in reference to the encoded data for two channels. The wireless transmission section 73 transmits the Lch packets and the Rch packets to the audio reproduction apparatus 62.

The wireless transmission section 81 of the audio reproduction apparatus 62 receives the Lch packets and the Rch packets transmitted from the audio server 61.

In step S12, by using the destination ID as a key, the packet sorting section 92 sorts the packets for each channel (packets directed to the audio reproduction apparatus 63 and packets directed to the other audio reproduction apparatus), and stores the former packets in the packet buffer 83-1, while storing the latter packets in the packet buffer 83-2.

In step S13, the audio reproduction apparatus 63 monitors packets transmitted between the audio server 61 and the audio reproduction apparatus 62. Thus, the wireless transmission section 91 of the audio reproduction apparatus 63 receives the Lch packets and Rch packets transmitted from the audio server 61.

In step S14, by using the destination ID as a key, the packet sorting section 92 of the audio reproduction apparatus 63 sorts the packets supplied from the wireless transmission section 91 into the packets directed to the audio reproduction apparatus 63 and the packets directed to the audio reproduction apparatus 62. The packet sorting section 92 stores, in the packet buffer 93, the packets directed to the audio reproduction apparatus 63, and discards the packets directed to the audio reproduction apparatus 62.

In step S15, the lost packet detection section 94 detects a lost packet. Specifically, the lost packet detection section 94 checks the sequence number added to each of the audio packets stored in the packet buffer 93, the audio packets including the destination ID indicating the audio reproduction apparatus 63.

In step S16, in a case where loss of a sequence number is detected, the lost packet detection section 94 requests a packet with the lost sequence number (lost packet) from the audio reproduction apparatus 62.

In step S17, in response to the request for the lost packet from the audio reproduction apparatus 63, the retransmission processing section 84 of the audio reproduction apparatus 62 requests the audio server 61 to control and reduce the encoding bit rate.

In step S18, in response to the request from the audio reproduction apparatus 62, the encode processing section 71 of the audio server 61 switches the encoding bit rate to a low bit rate.

In step S19, the retransmission processing section 84 of the audio reproduction apparatus 62 confirms that the encoding bit rate has been reduced, and then, in response to the request for the lost packet transmitted from the audio reproduction apparatus 63, retrieves, from the packet buffer 83-2, the Rch packet corresponding to the requested lost packet, and transmits the Rch packet to the audio reproduction apparatus 63.

The lost packet detection section 94 of the audio reproduction apparatus 63 receives the packet transmitted from the audio reproduction apparatus 62.

In step S20, in a case where transmission of the Rch packet to the audio reproduction apparatus 63 is completed, the retransmission processing section 84 of the audio reproduction apparatus 62 requests the audio server 61 to control and increase the encoding bit rate.

In step S21, in response to the request from the audio reproduction apparatus 62, the encode processing section 71 of the audio server 61 switches the encoding bit rate to a high bit rate.

As described above, the audio reproduction apparatus 63 is compensated for the lost packet, and has better reproduction quality than the known system in FIG. 1 and FIG. 2.

### 2. Second Embodiment (Multichannel Configuration

### (Configuration of Audio Reproduction System)

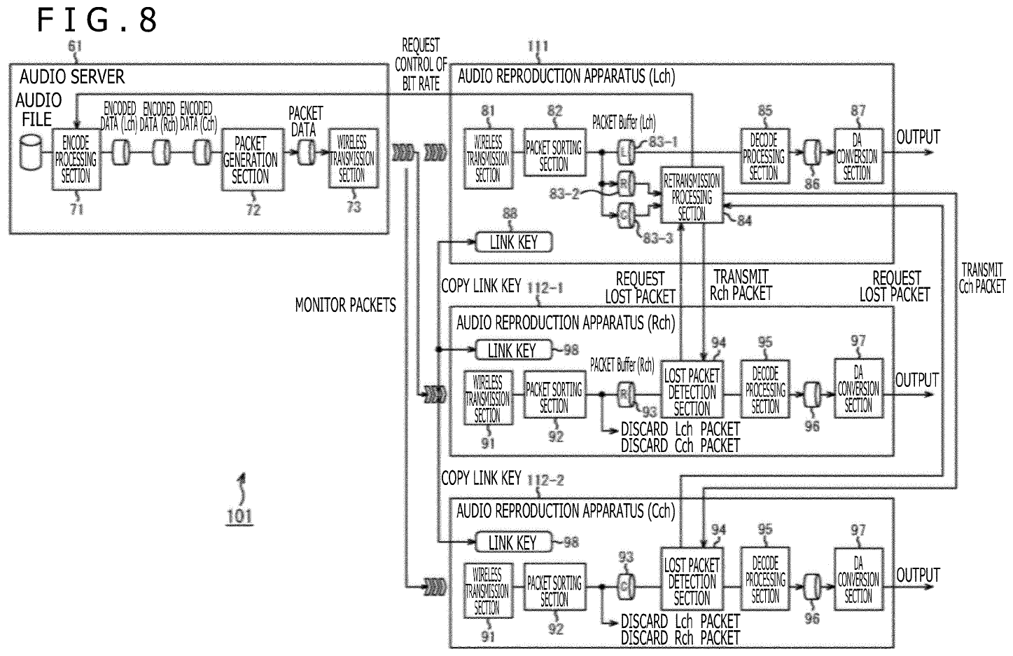

FIG. 8 is a block diagram depicting a configuration example of a second embodiment of the audio reproduction apparatus to which the present technology is applied.

An audio reproduction system 101 in FIG. 8 is a system that reproduces multi-channel audio data. FIG. 8 depicts an example of three channels. Note that portions in FIG. 8 corresponding to the portions in FIG. 3 are denoted by the corresponding reference signs and only different portions will be described in detail.

The audio reproduction system 101 includes the audio server 61 in FIG. 3, an audio reproduction apparatus 111 that reproduces audio data for Lch, an audio reproduction apparatus 112-1 that reproduces audio data for Rch, and an audio reproduction apparatus 112-2 that reproduces audio data for a Center channel (hereinafter referred to as Cch). The audio server 61 and the audio reproduction apparatus 111 are enabled to transmit data through the synchronization establishment procedure defined for wireless transmission.

In other words, the audio reproduction system 101 substantially corresponds to the audio reproduction system 51 in FIG. 3 to which the audio reproduction apparatus 112-2 is added.

The audio server 61 in FIG. 8 differs from the audio server 61 in FIG. 3 in that data to be monaurally encoded and packetized additionally includes audio data for Cch besides audio data for Lch and audio data for Rch.

The audio reproduction apparatus 111 differs from the audio reproduction apparatus 62 in that packets to be received and sorted additionally include packets for Cch besides packets for Lch and packets for Rch and that the audio reproduction apparatus 111 additionally includes a packet buffer 83-3 in which the packets for Cch are stored.

The audio reproduction apparatus 112-1 differs from the audio reproduction apparatus 63 in that packets to be sorted additionally include packets for Cch besides packets for Lch and packets for Rch and that packets to be discarded additionally include packets for Cch besides packets for Lch.

The audio reproduction apparatus 112-2 differs from the audio reproduction apparatus 63 in that packets to be reproduced are Cch packets, that packets to be sorted additionally include Cch packets besides Lch packets and Rch packets, and that packets to be discarded additionally include Rch packets besides Lch packets.

Note that the audio reproduction apparatuses 112-1 and 112-2 are referred to as the audio reproduction apparatus 112 in a case where the audio reproduction apparatuses 112-1 and 112-2 need not be distinguished from each other.

### (Example of Compensation Method)

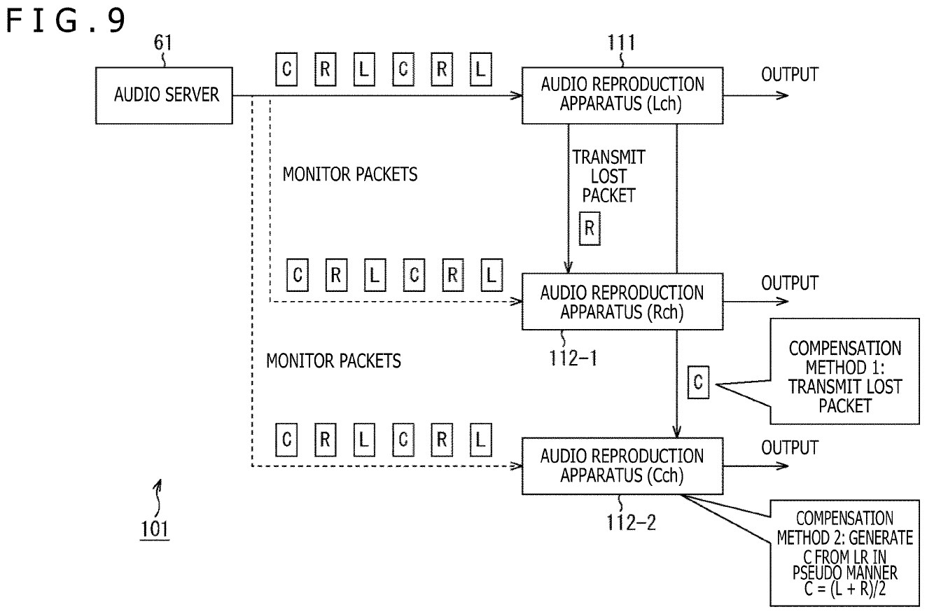

Now, with reference to FIG. 9, the compensation method in the audio reproduction apparatus 112-2 will be described.

In FIG. 9, Lch packets, Rch packets, and Cch packets encoded by the audio server 61 are sequentially transmitted and are received by the audio reproduction apparatus 111.

By monitoring packets transmitted between the audio server 61 and the audio reproduction apparatus 111, the audio reproduction apparatuses 112-1 and 112-2 receive the Lch packets, Rch packets, and Cch packets encoded by the audio server 61.

In a case where any lost packet is detected, the audio reproduction apparatus 112-1 requests the lost packet from the audio reproduction apparatus 111 as described above. The audio reproduction apparatus 111 retransmits an Rch packet corresponding to the requested lost packet. Thus, the audio reproduction apparatus 112-1 can receive the Rch packet corresponding to the requested lost packet and be compensated for the lost packet.

The audio reproduction apparatus 112-2 includes two compensation methods used in a case where any lost packet is detected.

The first compensation method is to request a lost packet from the audio reproduction apparatus 111 as is the case with the audio reproduction apparatus 112-1. Thus, the audio reproduction apparatus 112-2 can receive the Cch packet corresponding to the requested lost packet and be compensated for the lost packet.

The second compensation method is to compensate for a lost packet in a pseudo manner. Specifically, in a case of having received and stored Lch packets and Rch packets, the audio reproduction apparatus 112-2 performs the calculation (Lch packet+Rch packet)/2 to generate a Cch packet in a pseudo manner, compensating for the Cch packet.

In this case, no transmission band is required for transmission of the Cch packet, and hence the encoding bit rate for audio packets need not be reduced, so that the reproduction quality is improved with high sound quality maintained. Note that in this case, the audio reproduction apparatus 112-2 needs to include a buffer in which Lch packets and Rch packets are to be stored.

Further, in a case where the audio reproduction apparatus 112-1 detects a lost packet and Lch packets and Cch packets have been received and stored, then the audio reproduction apparatus 112-1 can compensate for an Rch packet by performing the calculation (2×Cch packet−Lch packet) to generate the Rch packet in a pseudo manner. Note that also in this case, the audio reproduction apparatus 112-1 needs to include a buffer in which Lch packets and Cch packets are to be stored.

Note that the second compensation method may be, instead of the simplified method described above, one achieving compensation by using error concealment data provided by the audio server 61 and past packets successfully received in the past.

### 3. Third Embodiment (Dynamic Addition of Reproduction Apparatus

### (Configuration of Audio Reproduction System)

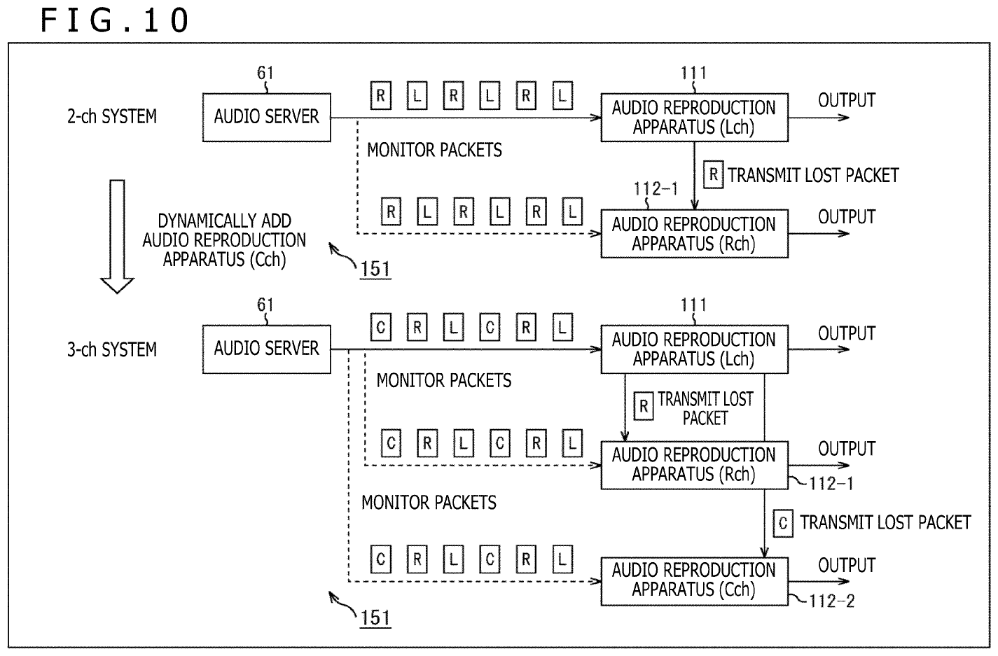

FIG. 10 is a diagram depicting a configuration example of a third embodiment of the audio reproduction apparatus to which the present technology is applied.

FIG. 10 depicts an audio reproduction system 151 that allows channels to be dynamically added. Note that portions in FIG. 10 corresponding to the portions in FIG. 8 are denoted by the corresponding reference signs and only different portions will be described in detail.

FIG. 10 depicts, in the upper portion of the diagram, the audio reproduction system 151 used in a case of reproducing audio data for two channels.

The audio reproduction system 151 includes the audio server 61, the audio reproduction apparatus 111 that reproduces audio data for Lch, and the audio reproduction apparatus 112-1 that reproduces audio data for Rch. The audio server 61 and the audio reproduction apparatus 111 are enabled to transmit data through the synchronization establishment procedure defined for wireless transmission.

In the upper portion of FIG. 10, Lch packets and Rch packets encoded by the audio server 61 are sequentially transmitted and are received by the audio reproduction apparatus 111.

By monitoring packets transmitted between the audio server 61 and the audio reproduction apparatus 111, the audio reproduction apparatus 112-1 receives the Lch packets and Rch packets encoded by the audio server 61.

FIG. 10 depicts, in the lower portion of the diagram, an audio reproduction system 151 used in a case of reproducing audio data for three channels.

As depicted in the lower portion of FIG. 10, the audio reproduction system 151 further includes the audio reproduction apparatus 112-2 that reproduces audio data for Cch. In this case, the audio reproduction apparatus 112-2 uses a method such as short-distance wireless communication to acquire the link key between the audio server 61 and the audio reproduction apparatus 111 from the audio reproduction apparatus 111.

The present technology as described above eliminates the need for the synchronization establishment procedure between the audio server 61 and the audio reproduction apparatus 112-2, thus allowing the audio reproduction apparatus 112-2 to be added without suspension of reproduction.

In response to transmission and reception of the link key to and from the audio reproduction apparatus 112-2, the audio reproduction apparatus 111 transmits, to the audio server 61, a notification signal for giving notice of addition of the audio reproduction apparatus 112-2. Reception of the notification signal causes the audio server 61 to recognize the number of the audio reproduction apparatus 111 and the audio reproduction apparatuses 112-1 and 112-2. According to the number of the audio reproduction apparatus 111 and the audio reproduction apparatuses 112-1 and 112-2, the audio server 61 determines the number of channels to be three, generates individual packets for Lch, Rch, and Cch, and transmits the packets to the audio reproduction apparatus 111.

Here, addition of the audio reproduction apparatus 112-2 changes a packet format, and hence, the buffer 83 of the audio reproduction apparatus 111 having finished reception may need to be cleared.

However, in the present technology, packets are generated for each channel, and thus even in the case of the audio reproduction apparatus 112-2 being added, audio packets with the destination ID indicating the audio reproduction apparatus 111 and audio packets with the destination IDs indicating other audio reproduction apparatuses may continue to be buffered in the same manner as before the addition.

In other words, the audio reproduction apparatus 111 need not clear the packet buffer 83-1 for Lch and can continue buffering with the packet buffer 83-1 and the decode processing. Further, the audio reproduction apparatus 111 need not clear the packet buffer 83-2 for Rch and can continue buffering with the packet buffer and 83-2 and prepare for a transmission request.

In addition, the audio reproduction apparatus 111 newly initiates buffering with the packet buffer 83-3 for Cch and prepares for a transmission request.

Note that in the audio reproduction apparatus 111 and the like, a packet buffer for an audio reproduction apparatus expected to be added is provided in advance or a packet buffer for an audio reproduction apparatus to be added is dynamically provided at the time of addition. Both methods can easily be implemented by software processing.

As described above, despite the addition of the audio reproduction apparatus 112-2, the audio reproduction apparatus 111 can select the packets directed to the audio reproduction apparatus 111, continue buffering with the packet buffer 83-1, and continue the reproduction processing without any change.

### 4. Fourth Embodiment (Installation in Multiple Rooms

### (Configuration of Audio Reproduction System)

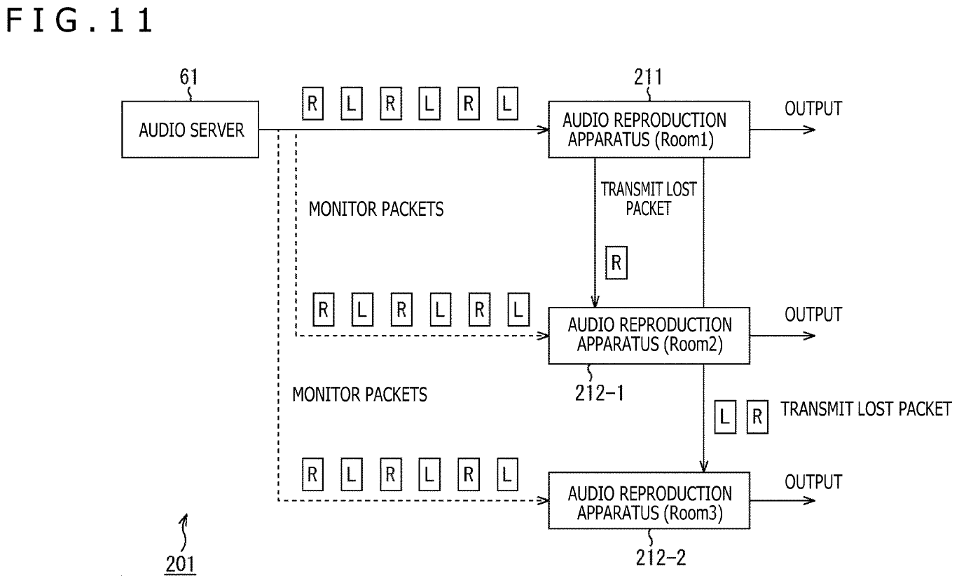

FIG. 11 is a diagram depicting a configuration example of a fourth embodiment of the audio reproduction apparatus to which the present technology is applied.

FIG. 11 depicts an audio reproduction system 201 installed in multiple rooms. Note that portions in FIG. 11 corresponding to the portions in FIG. 3 are denoted by the corresponding reference signs and only different portions will be described in detail.

The audio reproduction system 201 includes the audio server 61 in FIG. 3, an audio reproduction apparatus 211 installed in Room1, an audio reproduction apparatus 212-1 installed in Room2, and an audio reproduction apparatus 212-2 installed in Room3. The audio server 61 and the audio reproduction apparatus 211 are enabled to transmit data through the synchronization establishment procedure defined for wireless transmission.

Each of the audio reproduction apparatus 211, the audio reproduction apparatus 212-1, and the audio reproduction apparatus 212-2 includes stereo speakers that output sound for two channels Lch and Rch.

The audio reproduction apparatus 211 differs from the audio reproduction apparatus 62 in FIG. 3 in that the audio reproduction apparatus 211 decodes and reproduces Rch packets as well as Lch packets.

The audio reproduction apparatuses 212-1 and 212-2 differ from the audio reproduction apparatus 63 in FIG. 3 in that the audio reproduction apparatuses 212-1 and 212-2 store Rch packets and Lch packets in a packet buffer and decode and reproduce the Rch and Lch packets.

In FIG. 11, loss of an Rch packet occurs in the audio reproduction apparatus 212-1, and the audio reproduction apparatus 211 transmits the Rch packet. Only the lost packet needs to be transmitted, and hence the reproduction quality is better than that in the known stereo audio packet transmission in FIG. 1 and FIG. 2. Note that, in order to provide a transmission band for transmission of the lost packet, the encoding bit rate from the audio server 61 to the audio reproduction apparatus 211 needs to be reduced as described above with reference to FIG. 6.

Loss of an Rch packet and an Lch packet occurs in the audio reproduction apparatus 212-2, and the audio reproduction apparatus 211 transmits the Rch packet and the Lch packet. In this case, in order to provide a band for transmission of the lost packets, one of the following is applied: a method for suspending packet transmission from the audio server 61 to the audio reproduction apparatus 211 or a method for compensating for the lost packets in a pseudo manner as described above with reference to FIG. 9.

### 5. Fifth Embodiment (Streaming Service from Cloud

### (Configuration of Audio Reproduction System)

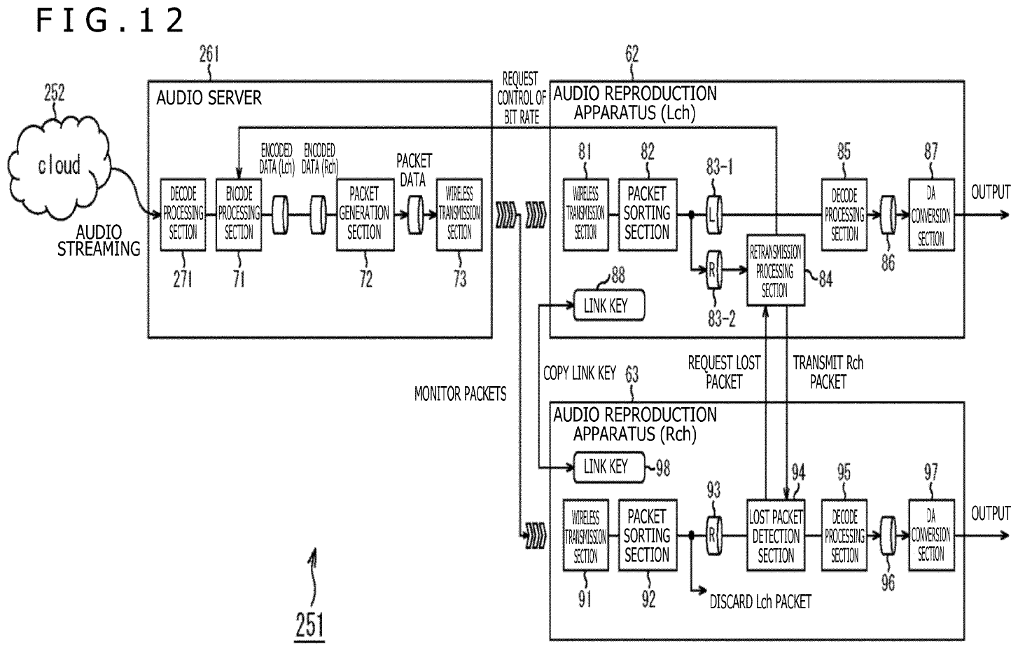

FIG. 12 is a block diagram depicting a configuration example of a fifth embodiment of the audio reproduction system to which the present technology is applied.

An audio reproduction system 251 in FIG. 12 is a system that reproduces audio data for streaming service from a cloud 252. Note that portions in FIG. 12 corresponding to the portions in FIG. 3 are denoted by the corresponding reference signs and only different portions will be described in detail.

The audio reproduction system 251 includes an audio server 261 and the audio reproduction apparatus 62 and audio reproduction apparatus 63 in FIG. 3. The audio server 261 and the audio reproduction apparatus 62 are enabled to transmit data through the synchronization establishment procedure defined for wireless transmission.

The audio server 261 differs from the audio server 61 in FIG. 3 in that the audio server 261 additionally includes a decode processing section 271.

The decode processing section 271 acquires audio data from the cloud 252. The audio data is typically transmitted in a stereo encoded form by the cloud 252.

The decode processing section 271 decodes audio data acquired from the cloud 252, and outputs the decoded audio data to the encode processing section 71. The encode processing section 71 monaurally encodes decoded data for each channel. The monaurally encoded data is packetized by the packet generation section 72, and the resultant packets are transmitted to the audio reproduction apparatus 62 in order of the Lch packet and the Rch packet.

Note that in the example illustrated in FIG. 12, the audio server 261 performs monaural encoding for each channel but encoded data for Lch and encoded data for Rch that result from monaural encoding in the cloud 252 may be obtained.

### 6. Others

### (Effects)

As described above, the present technology allows reproduction apparatuses using Bluetooth (registered trademark) or the like and including separate channels to achieve stable transmission at a high bit rate.

Specifically,
Only packets with the destination ID indicating the subject audio reproduction apparatus need to be loaded, leading to an approximately half error rate. The number of reproduction performed is also approximately halved.
Each audio reproduction apparatus needs to load only the packets with the destination ID indicating the subject audio reproduction apparatus, thus allowing the buffer size to be reduced.
The buffer size for audio packets required during transmission for a lost packet can also be reduced.
During transmission for a lost packet, audio packet transmission between the audio server and the audio reproduction apparatus is not stopped (transmission is continued at a low bit rate), allowing each audio reproduction apparatus to reduce the buffer size for prevention of sound breakup. As a result, a low latency system can be realized.

Further, in a multi-channel audio reproduction apparatus, in the case of a lost packet, the lost packet is generated in a pseudo manner, thus allowing reproduction to be continued with a high bit rate maintained and with no packets transmitted or received.

The function to add and remove a channel (a reproduction apparatus that reproduces audio data for the channel) can be dynamically implemented.

The audio reproduction apparatuses installed in multiple rooms need to transmit only lost packets, and thus the stereo audio packet transmission has higher reproduction quality than the known stereo audio packet transmission.

Streaming service from the cloud can also be used.

### (Configuration Example of Computer)

The above-described series of processing can be executed by hardware or by software. In a case where the series of processing is executed by software, a program constituting the software is installed, through a program recording medium, into a computer integrated into dedicated hardware, a general-purpose personal computer, or the like.

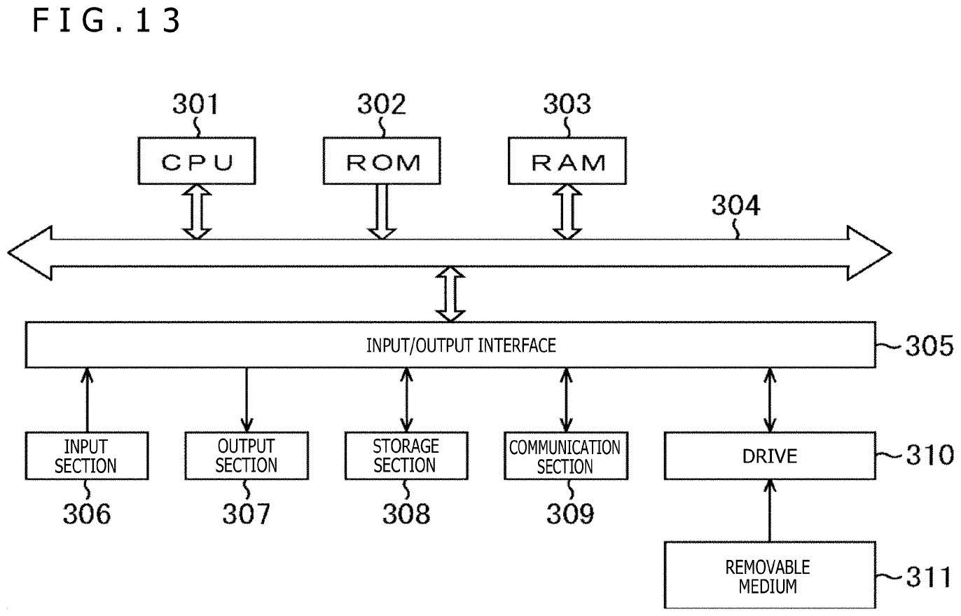

FIG. 13 is a block diagram depicting a configuration example of hardware of a computer that executes the above-described series processing in accordance with the program.

A CPU 301, a ROM (Read Only Memory) 302, and a RAM 303 are connected to each other by a bus 304.

The bus 304 further connects to an input/output interface 305. The input/output interface 305 connects to an input section 306 including a keyboard, a mouse, and the like and an output section 307 including a display, a speaker, and the like. Further, the input/output interface 305 connects to a storage section 308 including a hard disk, a nonvolatile memory, or the like, a communication section 309 including a network interface or the like, and a drive 310 that drives a removable medium.

In the computer configured as described above, the CPU 301, for example, executes the above-described series of processing by loading a program stored in the storage section 308 into the RAM 303 via the input/output interface 305 and the bus 304 and executing the program.

The program executed by the CPU 301 is, for example, provided by being recorded in the removable medium 311 or is provided via a wired or wireless transmission medium such as a local area network, the Internet, or digital broadcasting. The program is then installed into the storage section 308.

Note that the program executed by the computer may be a program in which processing operations are executed chronologically in the order described herein or a program in which processing operations are executed in parallel or at such required timings as when the program is invoked.

Note that the system as used herein means a set of multiple components (apparatuses, modules (parts), or the like) regardless of whether all the components are located in an identical housing. Consequently, both multiple apparatuses housed in separate housings and connected to each other via a network and an apparatus in which multiple modules are housed in one housing correspond to systems.

Further, the effects described herein are only illustrative and are not restrictive, and other effects may be produced.

The embodiments of the present technology are not limited to the above-described embodiments, and variations can be made to the embodiments without departing from the spirits of the present technology.

For example, the present technology can be configured as cloud computing in which one function is shared and processed by multiple apparatuses via a network.

Further, the steps described in the above-described flowcharts can be executed by one apparatus or by being shared by multiple apparatuses.

Furthermore, in a case where one step includes multiple processing operations, the multiple processing operations included in the step can be executed by one apparatus or by being shared by multiple apparatuses.

### <Examples of Combinations of Configurations>

The present technology can also be configured as follows.

(1)

A signal processing apparatus including:

a processing section that receives packets which are separated for respective channels and each additionally include identification information, stores the packets in a buffer in reference to the identification information, and decodes those of the packets which are directed to the signal processing apparatus.

(2)

The signal processing apparatus according to (1) described above, in which

the identification information includes at least one of a destination and a sequence number for each channel.

(3)

The signal processing apparatus according to (1) or (2) described above, further including:

a communication section that receives the packets transmitted from a server;

a packet sorting section that stores the packets in the buffer by sorting the packets into the packets directed to the signal processing apparatus and the packets directed to another signal processing apparatus, in reference to the identification information; and

a transmission processing section that transmits the packets directed to the another signal processing apparatus and stored in the buffer to the another signal processing apparatus in response to a request from the another signal processing apparatus.

(4)

The signal processing apparatus according to (3) described above, in which,

in response to the request for a lost packet transmitted from the another signal processing apparatus, the transmission processing section transmits, to the another signal processing apparatus, one of the packets that corresponds to the lost packet.

(5)

The signal processing apparatus according to (4) described above, in which

the transmission processing section requests the server to control an encoding bit rate depending on whether or not the packet corresponding to the lost packet is to be transmitted to the another signal processing apparatus.

(6)

The signal processing apparatus according to (5) described above, in which,

in a case of transmitting, to the another signal processing apparatus, the packet corresponding to the lost packet, the transmission processing section requests the server to control and reduce the encoding bit rate.

(7)

The signal processing apparatus according to (3) described above, in which,

in a case where transmission, to the another signal processing apparatus, of the packet corresponding to the lost packet ends, the transmission processing section requests the server to control and increase the encoding bit rate.

(8)

The signal processing apparatus according to any one of (3) to (7) described above, in which

the communication section transmits, to the server, a notification signal for giving notice of addition of the another signal processing apparatus, in response to transmission and reception of a link key to and from the another signal processing apparatus.

(9)

The signal processing apparatus according to (1) described above, further including:

a communication section that monitors communication between a sever and another signal processing apparatus and receives the packets transmitted from the server to the another signal processing apparatus.

(10)

The signal processing apparatus according to (9) described above, further including:

a packet sorting section that stores the packets directed to the signal processing apparatus, in the buffer in reference to the identification information, and discards the packets directed to the another signal processing apparatus.

(11)

The signal processing apparatus according to (9) described above, in which

the identification information includes a sequence number of each of the packets for each channel, and the signal processing apparatus further includes a lost packet detection section that detects a lost packet in reference to the identification information.

(12)

The signal processing apparatus according to (11) described above, in which

the lost packet detection section transmits a request for the lost packet detected to the another signal processing apparatus, and receives, from the another signal processing apparatus, the packet corresponding to the request.

(13)

The signal processing apparatus according to (11) described above, in which

the lost packet detection section compensates for the lost packet detected, by using one of the packets directed to the another signal processing apparatus and stored in the buffer.

(14)

The signal processing apparatus according to (1) described above, in which,

in response to a request for lost packet that is transmitted from another signal processing apparatus installed in a room different from a room in which the signal processing apparatus is installed, one of the packets that corresponds to the request, the packets being stored in the buffer, is transmitted to the another signal processing apparatus.

(15)

The signal processing apparatus according to any one of (1) to (14) described above, in which

the packets include audio data separated for each channel.

(16)

A signal processing method including:

receiving packets which are separated for respective channels and each additionally include identification information, storing the packets in a buffer in reference to the identification information, and decoding those of the packets which are directed to a subject signal processing apparatus.

(17)

An encoding method including:

separating audio data into data for respective channels and monaurally encoding the data;

generating a packet by adding identification information to the encoded data; and

transmitting the packet generated to a first signal processing apparatus.

(18)

The encoding method according to (17) described above, in which

the number of channels corresponding to the number of data into which the audio data is separated is controlled according to the number of the first signal processing apparatus and a second signal processing apparatus that monitors transmission of the packet to the first signal processing apparatus and that receives the packet.

(19)

The encoding method according to (18) described above, in which

the number of channels is notified by the first signal processing apparatus according to transmission and reception of a link key between the first signal processing apparatus and the second signal processing apparatus, the link key being shared with the first signal processing apparatus.

(20)

The encoding method according to (18) or (19) described above, in which

an encoding bit rate for the audio data is controlled in response to a request depending on whether or not the packet corresponding to a lost packet in the second signal processing apparatus is transmitted to the second signal processing apparatus from the first signal processing apparatus that transmits the packet to the second signal processing apparatus.

(21)

An encoding apparatus including:

an encoding section that separates audio data into data for respective channels and monaurally encodes the data;

a packet generation section that generates a packet by adding identification information to the encoded data; and

a transmission section that transmits the packet generated to a first signal processing apparatus.

(22)

A signal processing system including:

an encoding apparatus that
separates audio data into separate data for respective channels and monaurally encodes the data,
generates a packet by adding identification information to the encoded data, and
transmits the packet generated to a first signal processing apparatus,

the first signal processing apparatus that
receives the packet transmitted from the encoding apparatus,
stores the packet in a first buffer in reference to the identification information, and decodes the packet which is directed to the first signal processing apparatus, and,
in response to a request from a second signal processing apparatus, transmits, to the second signal processing apparatus, the packet directed to the second signal processing apparatus and stored in the first buffer; and

the second signal processing apparatus that
monitors communication between the encoding apparatus and the first signal processing apparatus and receives the packet transmitted from the encoding apparatus to the first signal processing apparatus,
stores the packet in a second buffer in reference to the identification information,
detects a lost packet in reference to the identification information, transmits, to the first signal processing apparatus, the request for the lost packet detected, and receives, from the first signal processing apparatus, the packet corresponding to the request, and
decodes the packet directed to the second signal processing apparatus.

### REFERENCE SIGNS LIST

51: Audio reproduction system
61: Audio server
62: Audio reproduction apparatus
63: Audio reproduction apparatus
71: Encode processing section
72: Packet generation section
73: Wireless transmission section
81: Wireless transmission section
82: Packet sorting section
83-1 to 83-3: Packet buffer
84: Retransmission processing section
85: Decode processing section
86: PCM buffer
87: DA conversion section
88: Link key storage section
91: Wireless transmission section
92: Packet sorting section
93: Packet buffer
94: Lost packet detection section
95: Decode processing section
96: PCM buffer
97: DA conversion section
98: Link key storage section
101: Audio reproduction system
111: Audio reproduction apparatus
112-1, 112-2: Audio reproduction apparatus
151: Audio reproduction system
201: Audio reproduction system
211: Audio reproduction apparatus
212-1, 212-2: Audio reproduction apparatus
251: Audio reproduction system
252: Cloud
261: Audio server
271: Decode processing section

1. A signal processing apparatus comprising:
a processing section that receives packets which are separated for respective channels and each additionally include identification information, stores the packets in a buffer in reference to the identification information, and decodes those of the packets which are directed to the signal processing apparatus.

2. The signal processing apparatus according to claim 1, wherein
the identification information includes at least one of a destination and a sequence number for each channel.

3. The signal processing apparatus according to claim 1, further comprising:
a communication section that receives the packets transmitted from a server;
a packet sorting section that stores the packets in the buffer by sorting the packets into the packets directed to the signal processing apparatus and the packets directed to another signal processing apparatus, in reference to the identification information; and
a transmission processing section that transmits the packets directed to the another signal processing apparatus and stored in the buffer to the another signal processing apparatus in response to a request from the another signal processing apparatus.

4. The signal processing apparatus according to claim 3, wherein,
in response to the request for a lost packet transmitted from the another signal processing apparatus, the transmission processing section transmits, to the another signal processing apparatus, one of the packets that corresponds to the lost packet.

5. The signal processing apparatus according to claim 4, wherein
the transmission processing section requests the server to control an encoding bit rate depending on whether or not the packet corresponding to the lost packet is to be transmitted to the another signal processing apparatus.

6. The signal processing apparatus according to claim 5, wherein,
in a case of transmitting, to the another signal processing apparatus, the packet corresponding to the lost packet, the transmission processing section requests the server to control and reduce the encoding bit rate.

7. The signal processing apparatus according to claim 5, wherein,
in a case where transmission, to the another signal processing apparatus, of the packet corresponding to the lost packet ends, the transmission processing section requests the server to control and increase the encoding bit rate.

8. The signal processing apparatus according to claim 3, wherein
the communication section transmits, to the server, a notification signal for giving notice of addition of the another signal processing apparatus, in response to transmission and reception of a link key to and from the another signal processing apparatus.

9. The signal processing apparatus according to claim 1, further comprising:
a communication section that monitors communication between a sever and another signal processing apparatus and receives the packets transmitted from the server to the another signal processing apparatus.

10. The signal processing apparatus according to claim 9, further comprising:
a packet sorting section that stores the packets directed to the signal processing apparatus, in the buffer in reference to the identification information, and discards the packets directed to the another signal processing apparatus.

11. The signal processing apparatus according to claim 9, wherein
the identification information includes a sequence number of each of the packets for each channel, and
the signal processing apparatus further includes a lost packet detection section that detects a lost packet in reference to the identification information.

12. The signal processing apparatus according to claim 11, wherein
the lost packet detection section transmits a request for the lost packet detected to the another signal processing apparatus, and receives, from the another signal processing apparatus, the packet corresponding to the request.

13. The signal processing apparatus according to claim 11, wherein
the lost packet detection section compensates for the lost packet detected, by using one of the packets directed to the another signal processing apparatus and stored in the buffer.

14. The signal processing apparatus according to claim 1, wherein,
in response to a request for a lost packet that is transmitted from another signal processing apparatus installed in a room different from a room in which the signal processing apparatus is installed, one of the packets that corresponds to the request, the packets being stored in the buffer, is transmitted to the another signal processing apparatus.

15. The signal processing apparatus according to claim 1, wherein
the packets include audio data separated for each channel.

16. An encoding method comprising:
separating audio data into data for respective channels and monaurally encoding the data;
generating a packet by adding identification information to the encoded data; and
transmitting the packet generated to a first signal processing apparatus.

17. The encoding method according to claim 16, wherein
the number of channels corresponding to the number of data into which the audio data is separated is controlled according to the number of the first signal processing apparatus and a second signal processing apparatus that monitors transmission of the packets to the first signal processing apparatus and that receives the packets.

18. The encoding method according to claim 18, wherein
the number of channels is notified by the first signal processing apparatus according to transmission and reception of a link key between the first signal processing apparatus and the second signal processing apparatus, the link key being shared with the first signal processing apparatus.

19. The encoding method according to claim 17, wherein
an encoding bit rate for the audio data is controlled in response to a request depending on whether or not the packet corresponding to a lost packet in the second signal processing apparatus is transmitted to the second signal processing apparatus from the first signal processing apparatus that transmits the packet to the second signal processing apparatus.

20. A signal processing system comprising:
an encoding apparatus that
separates audio data into separate data for respective channels and monaurally encodes the data,
generates a packet by adding identification information to the encoded data, and
transmits the packet generated to a first signal processing apparatus;
the first signal processing apparatus that
receives the packet transmitted from the encoding apparatus,
stores the packet in a first buffer in reference to the identification information, and decodes the packet which is directed to the first signal processing apparatus, and,
in response to a request from a second signal processing apparatus, transmits, to the second signal processing apparatus, the packet directed to the second signal processing apparatus and stored in the first buffer; and
the second signal processing apparatus that
monitors communication between the encoding apparatus and the first signal processing apparatus and receives the packet transmitted from the encoding apparatus to the first signal processing apparatus,
stores the packet in a second buffer in reference to the identification information,
detects a lost packet in reference to the identification information, transmits, to the first signal processing apparatus, the request for the lost packet detected, and receives, from the first signal processing apparatus, the packet corresponding to the request, and
decodes the packet directed to the second signal processing apparatus.
